(19) United States
(12) Patent Application Publication
(10) Pub. No.: US 2007/0112582 A1
(43) Pub. Date: May 17, 2007

(54) Method for value-added reselling of marketing leads from multiple lead sources

(76) Inventor: Sean Fenlon, Marriottsville, MD (US)

Correspondence Address: Royal Craig;Ober/Kaler, Suite 800, 120 East Baltimore Street, Baltimore, MD, 21202, US

(21) Appl. No.: 11/599,922

(22) Filed: Nov. 14, 2006

Related U.S. Application Data
(60) Provisional application No. 60/736,894, filed on Nov. 15, 2005.

(51) Int. Cl. G06Q 99/00

(52) U.S. Cl. 705/1

(57) ABSTRACT

A method for value-added resales of leads originated by multiple lead sources. A reseller purchases unqualified leads on a contingent basis from multiple lead sources, consolidates all marketing leads from the various lead sources in a database, scrubs the lead data to ensure integrity (dupes are eliminated, phone numbers are screened against do-not-call-lists, and checks data integrity by pre-defined “filters”. The leads are then double-confirmed by call centers that attempt to make contact with the prospects. If contact is made, a live call center agent pre-qualifies and confirms the prospect's interest in speaking to a vendor. The call center agent then initiates a live telephone conference transfer of the lead to the vendor, while the vendor has concurrent access to the lead data in the database. This lead double-qualification process (and contingent purchase arrangement) ensures that the vendor is able to speak with a live interested and pre-qualified prospect 100% of the time, justifies a value-added margin to the reseller, and allows a steady cash flow to the reseller.

### CROSS-REFERENCE TO RELATED APPLICATIONS

The present application derives priority from provisional patent application No. 60/736,894, filed 15 Nov. 2005.

### BACKGROUND OF THE INVENTION

(1) Field of the Invention

The present invention relates to the commercialization of marketing leads and, more specifically, to a business method for purchasing marketing leads and for value-added resale of double-qualified live telephone transfers.

(2) Description of the Background

Many companies attempt to increase sales by purchasing marketing leads from vendors called “lead sources.” There are good and bad lead sources. The quality of the leads that they sell, the age of the leads, and the number of times each lead is sold are all critical factors in determining the value of the leads. Indeed, any one of these factors may greatly dilute the value of a lead. For example, a lead may be new and reasonably priced, and yet if it originated from a college yearbook it may have almost no value in the mortgage industry. It would be far more preferable to purchase mortgage leads from a list of names of homeowners, or even better, from a list of names of homeowners who purchased their homes when mortgage rates were high.

Marketing leads may originate from outbound telephone marketing, internet inquiries, TV advertisements, radio, via direct mailings, etc. There are myriad lead vendors each soliciting their various types of leads, at various quality levels. Vendors are not well-equipped to consolidate these various leads from various lead sources, and are typically unwilling to partake in outbound marketing themselves because it is too time consuming. The wasted time may be because no contact is ever made with the lead despite constant repeated efforts to contact, or because the lead is not interested after contact is made, or because actual interested consumers do not qualify for various reasons. As a result, an industry has developed for third party value-added resellers of marketing leads who assist in consolidating marketing leads, pre-qualifying the leads, actually making contact with the leads, and reselling the “pre-screened” leads to vendors. This is especially true in the mortgage industry where the term “live call transfer” has been gaining popularity. A live call transfer is a live telephone transfer of a prospective purchaser from a third party lead reseller to a vendor, the prospect having already been prequalified and having expressed an interest in speaking to the vendor. Vendors who purchase live call transfers typically receive a much higher rate of return, and a better value despite a slightly higher price paid for their leads. Of course, in order to make a living from reselling leads, the third party resellers must typically have an ample supply (purchasing their leads from numerous lead sources), make judicious purchase price decisions, must consolidate and pre-qualify their leads scrupulously, and must set their resale price at a level that justifies their value-added services to the vendors. The vendors would like a 100% contact rate of only interested and qualified prospects.

The general concept of aggregating third party leads (lead calls and forms) on the front end, storing in a database, pre-screening the leads with filters, and then transferring in real time to a call center is well-established, as seen in U.S. Pat. Nos. 6,934,379 and 6,320,956 both to Falcon et al., U.S. Application No. 20050137968 by Mitchell, and as described in the background section of the U.S. Application No. 20050249198 application by Goldman.

iLeadMachine Software, Inc. also markets Promero, a web based software application capable of providing real-time distribution of leads to a specific sales agent based on client defined rules (after data scrubbing, filtering and pre-screening). While real-time distribution of a call to a vendor sales agent ensures a 100% contact rate, it does not guarantee an interested and qualified prospect.

None of the foregoing nor any other known prior art business methods are capable of value-added resale of leads purchased on a contingent basis from multiple lead sources by consolidation of the leads, scrubbing the data, matching the lead data to vendor profiles, double-confirmation by live call centers that attempt to make contact with the prospects, prequalification of the prospects by a live call center agent in accordance with the vendor's profile, and a live “hot” transfer by conference call to the matched vendor, and finally, payment. There remains a need for a third-party marketing lead resale value-added service that makes vendor sales agents more productive via a 100% contact rate of only interested and pre-qualified prospects that have been specifically matched to that vendor.

### SUMMARY OF THE INVENTION

It is therefore an object of the present invention to provide a business method for value-added reselling of leads that gives vendors a 100% contact rate of only interested and pre-qualified prospects that have been specifically matched to that vendor.

It is another object to provide a business method for value-added reselling of leads as above that consolidates leads from multiple lead sources, scrubs the lead data, matches the lead data to vendor profiles, double-confirms the leads via live calls from call centers that attempt to make contact with the prospects and prequalify them, and finally completes a live “hot” transfer by conference call to the matched vendor.

It is another object to provide a business method for value-added reselling of leads as above that ensures a return for the reseller by a contingent purchase and sale pricing structure in which leads from multiple lead sources are purchased on a contingent basis (contingent on a successful live telephone transfer of the lead to a vendor), and vendors are likewise charged for each lead upon a successful live transfer, the transaction taking place automatically upon completion of the live call transfer to the matched vendor, thereby ensuring a predictable profit margin to the reseller.

The present method requires that the reseller have access to a public switched telephone network (PSTN), voice-over-IP (VOIP), or other telephone infrastructure with a call interface or gateway for computer networks (capable of translating control signals from one protocol, such as IP based packet data with PSTN or relevant protocol for interfacing to the PSTN). The reseller must also possess one or more back-end web-enabled servers communicating over the Internet and hosting an SQL (structured query language) database. Finally, the reseller should have access to the services of a telephone call center with “power dialers” and live agents, so that lead data can be loaded into power dialers and called for a number of days.

In accordance with the foregoing objects, the present invention is a business method for value-added reselling of leads originated by multiple lead sources by the steps of:

1) consolidating marketing leads from the various lead sources in a computer database;

2) pre-qualifying the lead data by “scrubbing” it to ensure integrity (dupes are eliminated, phone numbers are screened against do-not-call-lists, and consumers are qualified by pre-defined “filters”);

3) purchasing pre-qualified leads on a contingent basis from the multiple lead sources, payment ultimately being contingent on a successful live transfer of the lead prospect to a paying vendor.

4) double-confirming the leads using call centers that attempt to make contact with the prospects, first via power dialers. The leads are loaded into power dialers and called for a variable amount of time. If no contact is made after an optimized number of business days, the leads are removed from the queue. If/when contact is made a live call center agent confirms the prospect's interest in speaking to a vendor.

5) matching the double-confirmed (and scrubbed and contingent-purchased) leads to a vendor profile previously entered in the database to select a vendor for the live transfer. This can occur before, during or just following the double-confirmation step.

6) making the live “hot” transfer of the prospect to the matched vendor. Specifically, once the prospect has been connected and pre-qualified by a live call center agent, and the agent has confirmed the prospect's interest in speaking to a vendor, the call center agent makes the transfer by placing the prospect on hold, initiating a second call to the designated vendor, announcing a scripted “Hello, this is [call center agent's name] calling from the call center. I have John Doe on the line. His phone number is 949-555-1212”

The vendor simply enters the prospect's phone number into a telephone lookup form on the reseller's website, and the phone number lookup brings up the lead sheet data associated with the prospect.

The call center agent takes the prospect off of hold establishing a three-way conference call, and introduces the two parties by a scripted “Hello John, I have [loan officer's name]. He can help you with that product. Go ahead [loan officer's name]”. The call center agent drops off the teleconference.

This process ensures that the vendor is able to speak with a live interested and pre-qualified prospect 100% of the time.

Moreover, the double positive multi-channel process has the following advantages.

Multiple Lead Sources: The DP process includes the capacity to receive leads from an unlimited number of supply channels, with discreet processing and reporting on each one.

Data Scrubbing (Do Not Call, etc.): All phone numbers listed within lead data are scrubbed against National, State and Internal Do-Not-Call lists.

Lead Sources are incentivized to provide quality leads by unique sliding scale payment method that rewards lead suppliers with highest overall transfer ratio.

Unlimited Client Capacity/Unlimited Order Filters Capacity: the capacity to manage a virtually unlimited number of vendors/clients (along with their unique order parameters), with discreet management, processing, and reporting.

Multiple Call Center Channels: accommodates multiple call center operations, thus providing redundancy of the function and the ability to identify and optimize performance of multiple call center operations on a comparative side-by-side basis.

The vendor's sales agents instantly become more productive via a 100% contact rate of only interested and pre-qualified prospects.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a high-level diagram of the method for purchasing marketing leads and for value-added resale of pre-qualified live telephone transfers according to the present invention.

FIG. 2 is a more detailed step-by-step flow chart of the method for purchasing marketing leads and for value-added resale of pre-qualified live telephone transfers as in FIG. 1.

### DETAILED DESCRIPTION OF THE PREFERRED EMBODIMENT(S)

The present invention is a business method for value-added reselling of leads originated by multiple lead sources. The method transforms numerous lead prospects from numerous lead suppliers, the leads being of unknown quality, into a double-confirmed live telephone inquiry between a curious consumer and a vendor of interest. To do this the present method consolidates marketing leads from the various lead sources in computer database, pre-qualifies the leads by “scrubbing” them to ensure integrity (dupes are eliminated, phone numbers are screened against do-not-call-lists, and consumers are qualified by pre-defined “filters”); purchases the pre-qualified leads on a contingent basis (contingent on a successful live transfer of the lead prospect to a paying vendor; double-confirms the leads using call centers to contact the prospects and verify the prospect's interest in speaking to a vendor; matches the double-confirmed leads to a select vendor; makes a live “hot” transfer of the prospect to the matched vendor by conference call, and completes payment therefore.

The present method requires that the reseller have access to a public switched telephone network (PSTN) infrastructure, voice-over IP (VOIP) structure or other suitable teleconferencing infrastructure with a call interface or gateway for computer networks (capable of translating control signals from one protocol, such as IP based packet data with PSTN or relevant protocol for interfacing to the PSTN). There are various solutions for this including a POTS/Packet Bridge architecture, voice-over-internet (VOIP), softswitches (software switching solutions), and the reseller subscribe with an existing PSTN carrier having appropriate capabilities.

The reseller must also own one or more back-end web-enabled servers communicating over the Internet and hosting an SQL (structured query language) database. The back-end server(s) may run on any backend architecture such as a web-enabled Microsoft platform including Windows 2000 Advanced Server edition and MS SQL Server 2000. Data extracted from lead sources as well as the lead prospects themselves populates an SQL database.

Finally, the reseller should have access to the services of a telephone call center with “power dialers” and live agents, so that lead data can be loaded into power dialers and called for a number of days. There are a variety of conventional power dialers that redial a number (15 to 25 times a minute), and sound an alarm when it connects.

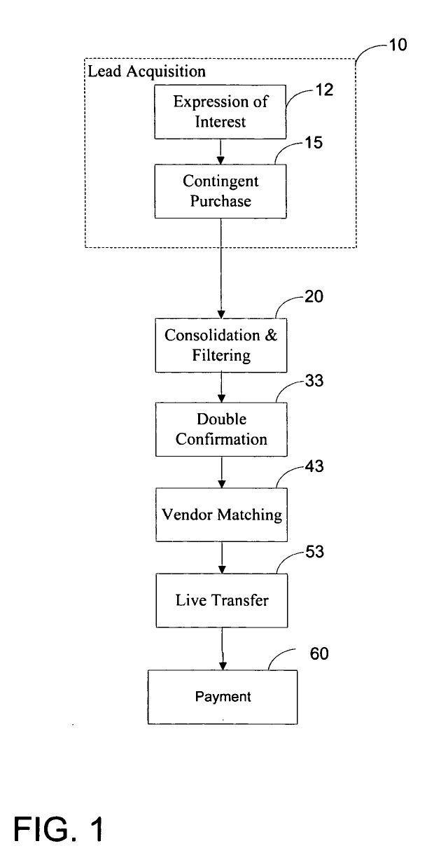

FIG. 1 is a high-level diagram of the method for value-added resale of pre-qualified live telephone transfers according to the present invention, which outlines the six general steps: 1) lead acquisition 10; 2) consolidation & filtering 20; 3) double verification 33; 4) vendor matching 43; 5) live transfer 53; and 6) payment 60. Each of these steps is described in detail.

Step 10: Lead Acquisition

First, at sub-step 12 consumers (prospects) express interest in receiving information and or a quote through one of several different methods. For example, the prospect may submit a form on the Internet requesting product/service information and or a quote. Prospects may arrive at this point via email advertisements offering product/service information and or a quote, web banner ads offering information and/or a quote, search engines optimized by keywords such as Refinance,” “Debt Consolidation Mortgage,” etc., fruitful solicitations by a telemarketing representative, or call-ins from consumers in response to various online/offline advertising channels, requesting product/service information and or a quote.

The foregoing leads come in through a variety of different types of lead suppliers which are described in detail below. In all such cases the consumer expresses interest in receiving product/service information and or a quote, and provides some basic information.

Next, at substep 15, the present reseller makes a contingent purchase of the leads. The reseller contracts with lead suppliers to purchase their leads on a contingent basis (typically multiple contracts will be executed to provide a ready supply of leads from multiple (an unlimited number of) lead suppliers). The reseller's payment for the leads is expressly conditioned on the execution of a successful live transfer of the lead prospect to a willing vendor. Moreover, lead sources are incentivized to provide quality leads by unique sliding scale payment method that rewards lead suppliers with highest overall transfer ratio.

Step 20: Lead Consolidation/Filtering.

The reseller first consolidates all contingent-purchased marketing leads from the various lead sources in an SQL database. Once the lead data is consolidated, the system scrubs the lead data to ensure integrity. Specifically, duplicate leads are eliminated from the database, phone numbers are screened against do-not-call-lists, and data integrity is checked by pre-defined “filters” to identify and eliminate leads with bad zip codes, misspelled names, incomplete name and addresses, etc.

Step 33: Double Confirmation

The consolidated/filtered/matched leads are compiled into a listing or “queue” which is transmitted electronically to one or more call centers (which may be in-house at the reseller or an independent contractor). The leads are double-confirmed by the call center. Specifically, the call center will attempt to make contact with the prospects, first via power dialers and then by live call center agents. The leads are loaded into power dialers and called for a predetermined time period (for example, three consecutive business days). If no contact is made after an optimized number of business days, the leads are removed from the queue and are deleted from the database. Of course, no payment is transacted to the lead supplier or from the matched vendors since the contracts are contingent on a successful live transfer.

If contact is made, live call center agents will pick up the call from the power dialer and prequalify the prospect and double-confirm their interest in speaking to a vendor representative. If the prospect is qualified and double-confirmed the call center agent will ask to place them on hold. Again, if the prospect is not qualified or not interested, the call is dropped and that lead is removed from the list and the database. No payment is transacted.

Step 43: Matching to Vendor Profiles

The consolidated/filtered/pre-qualified leads are then automatically matched to vendor profiles previously entered in the database to ensure that each selected lead for resale is targeted to particular vendor(s) (the reseller may resell each lead multiple times, preferably limited to four times).

Step 53: Live Transfer

Given the appropriate vendor profile, the call center agent then removes the prospect from hold, and initiates a second call to the vendor, announcing a scripted “Hello, this is [call center agent's name] calling from the call center. I have John Doe on the line. His phone number is 949-555-1212”.

The vendor agent is likewise provided with access to the reseller's web page and the lead sheet data associated with the prospect.

Once the vendor agent confirms access to the lead sheet data associated with that prospect, the call center agent initiates the live transfer by taking the prospect off of hold establishing a three-way conference call, and introducing the two parties by a scripted “Hello John, I have [loan officer's name]. He can help you with that product. Go ahead [loan officer's name]”. The call center agent drops off the teleconference

Step 70: Payment

Once a live transfer of a double-confirmed lead is made, the vendors account is debited for the price of the live transfer, and the lead source account is credited for the contingent and sliding-scale purchase price of the successful lead (as will be described).

The vendor's sales agents instantly become more productive via a 100% contact rate of only interested and pre-qualified prospects that have been specifically matched to that particular vendor. The reseller only pays for leads that it has been prepaid for by vendors, at a substantial premium that is justified by the reseller's ability to turn a vast pool of unqualified leads into a focused pool of double-qualified leads passed on via a live “hot” transfer by conference call to the matched vendor.

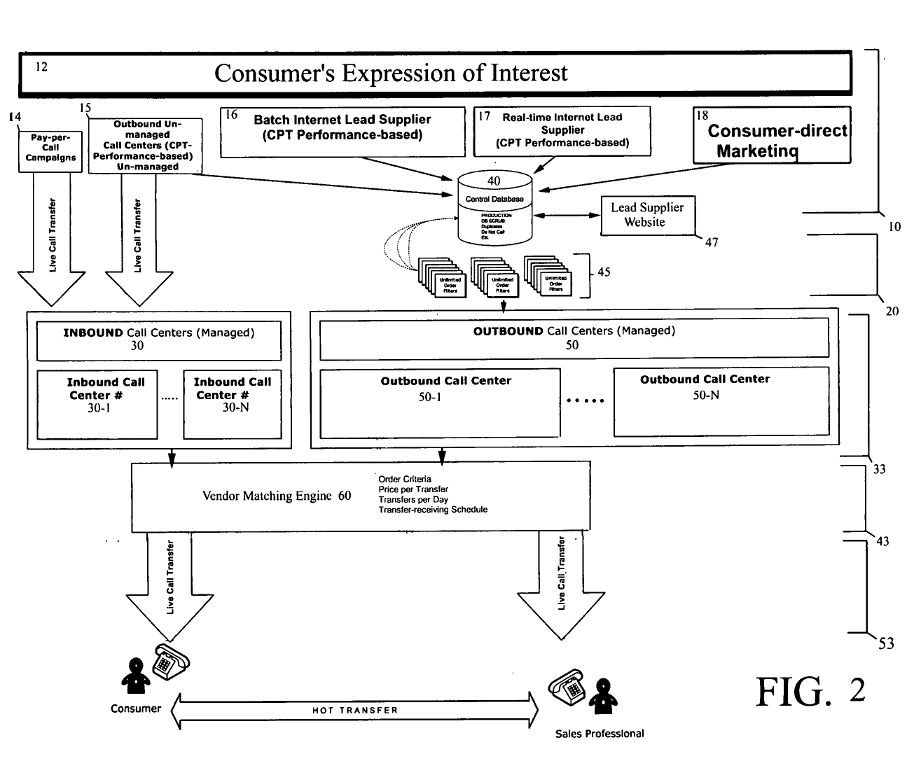

The foregoing method will now be described in more detail with reference to FIG. 2, which is a more detailed step-by-step flow chart of the method for purchasing marketing leads and for value-added resale of pre-qualified live telephone transfers as in FIG. 1.

The method begins with lead acquisition 10 (at top). Initially, at substep 12 consumers must express an interest in receiving information and/or a quote on a vendor's product or service. This may be by submission of a form on the Internet, an email response, solicitation to a telemarketing representative, or any of numerous response types typically to third-party “lead suppliers” who solicit these leads.

The leads come in through a variety of different types of lead suppliers including those at 14 running Pay-per Call Campaigns, Outbound Un-managed Call Centers 15, Batch Internet Lead Suppliers 16, Real-time Internet Lead Suppliers 17, or by consumer direct marketing 18.

Pay-per Call Suppliers 14 (such as Ingenio™) place vendor-specific ads on websites and print media soliciting consumer call-ins. Live calls come in from consumers expressing an interest in a product or service, and the Pay-per Call Supplier 14 will sell this call to the current reseller, usually at a fixed price. These are live expressions of interest and need not be pre-screened, and so these calls are forwarded directly to the reseller's inbound managed call center(s) 30-1 . . . N.

Outbound Un-managed Call Centers 15 include traditional telemarketers, both domestic and foreign, that solicit consumers by phone in real time. If a consumer expresses an interest in a product or service, the Outbound Un-managed Call Centers 15 will compile a lead data sheet (containing preliminary consumer information) and will sell the live call and data to the current reseller. Again these are live expressions of interest and these calls are forwarded directly to the reseller's inbound managed call center(s) 30-1 . . . N. However, they are responses to outbound solicitations and have widely varying integrity. Consequently, the present reseller subjects the Outbound Un-managed Call Centers 15 to its performance-based payment scheme (as will be described) in accordance with the present invention, and the success rate of the Outbound Un-managed Call Centers 15 is tracked. This entails forwarding the consumer data sheet to the present reseller's central database 40 and subjecting the data to lead filters 45 as will be described.

Batch Internet Lead Suppliers 16 compile batch lists of leads, usually by data mining and from published lists on the internet. The leads are compiled into a list for sale, and Batch Internet Lead Suppliers 16 typically sell such lists a limited number of times (up to four in the mortgage industry). The lists may be formatted and populated in myriad different ways. Thus, these leads and suppliers range from good to poor, and the present reseller subjects Batch Internet Lead Suppliers 16 to its performance-based payment scheme (as will be described) and this form of lead data is transmitted to the present reseller's central database 40 where it is likewise subjected to lead filters 45 as will be described. The reseller can accept batch leads in any standard data file format.

Real-time Internet Lead Suppliers 17 are similar to batch but forward their leads in real time as they are captured by internet search engines. The present reseller will accept batch leads from Real-time Internet Lead Suppliers 17 in real-time using any suitable transmission (e.g., XML web service post, http query string post, FTP upload, etc.). Again, the leads from Real-time Internet Lead Suppliers 17 are subjected to the reseller's contingent/performance-based payment scheme and the real-time forwarded leads are transmitted to the present reseller's central database 40 where it is subjected to lead filters 45.

The present reseller (as opposed to third party lead suppliers) may initiate its own consumer direct marketing 18 and these self-generated leads will also be filtered.

All of the foregoing leads may be acquired by the reseller. All lead data from Outbound Un-managed Call Centers 15, Batch Internet Lead Suppliers 16, Real-time Internet Lead Suppliers 17, and consumer direct marketing 18 lead suppliers are electronically transmitted to the present reseller's database 40.

In accordance with the present invention, any Batch Internet Lead Supplier 16 or Real-time Internet Lead Supplier 17 wishing to sell their leads to the present reseller may do so pursuant to the reseller's unique contingent/performance-based pricing strategy. Under this pricing strategy, the reseller publishes a minimum price (say $20) per lead and a high-end price (say $35) per lead. The actual price awarded depends on the overall live transfer ratio achieved by the reseller and varies from the minimum for resellers that sell poor quality leads (that do not result in live transfers to vendors) to the maximum for resellers that sell high quality leads (those with a high live transfer ratio). In addition to this performance-based pricing scheme, the reseller's payment obligation for each lead is made contingent on the lead being “acceptable” and resulting in a live transfer to a vendor. A lead is acceptable so long as it is not a duplicate, missing required fields, or is in any other way outside of the predetermined parameters of the Order Filters 45. These parameters are published in advance, and as the leads arrive at the database 40 the filters 45 are applied to ensure that the leads match the published filter parameters. The parameters may change somewhat as a matter of design choice, but all duplicate leads, and leads missing any of the required fields for each lead (currently approximately 15 including name, address, phone number, etc.) are rejected and returned. A lead is also rejected and returned (and not paid for) if it fails to result in a live telephone transfer from consumer-reseller to consumer-vendor within a predetermined optimum timeframe, currently three (3) days. The reseller simply returns all leads that are not “acceptable” or do not result in a live transfer. The foregoing contingent/performance-based pricing is a novel aspect of the present system inasmuch as it encourages lead suppliers to provide fresh leads, which always result in a higher transfer ratio and thereby increase the price paid per lead.

To overcome any lead supplier hesitation at subjecting their leads to price variability the reseller maintains a lead supplier website 47 in association with the database 40 that includes analytics to give lead vendors the ability to submit their leads and estimate their overall live transfer ratio before committing to sell their leads to the reseller.

Under the foregoing pricing conditions the reseller subscribes various lead suppliers to provide their leads under the foregoing terms, and the lead suppliers commit to sell.

Next, at the consolidation/filtering step 20, the reseller first consolidates all marketing leads from the various lead suppliers into the SQL database 40. This is accomplished by data migration and merge software that identifies discrete fields of data (name, address, phone number, etc.) on the various lead supplier data formats and then migrates the appropriate fields into the resellers SQL database 40. This process can be assisted by use of SQL Server Migration Assistant®, a set of Microsoft migration tools that helps speed the migration of data from other non-uniform databases to SQL Server, albeit the exact templates must be customized based on the characteristics of the lead supplier's data. Nevertheless, the resulting automation gives the capacity to receive leads from an unlimited number of supply channels, with discreet processing and reporting for each one.

The lead data is then “scrubbed” to ensure integrity. This likewise entails running data filtering software that checks for and eliminates duplicate leads, compares phone numbers to published “do-not-call” lists (preferably Federal, and optionally state and/or Internal Do-Not-Call lists), filters any inappropriate leads (those listing names such as John Doe or phone numbers such as 555-1212), and checks data integrity (deleting leads that are missing key fields such as call-back numbers). Any number of programmable custom filters may be implemented.

In addition to taking in lead data from lead suppliers, the reseller subscribes vendors to receive their services, and opens accounts for each one. In each case a vendor profile is collected and is entered into the SQL database 40. The vendor profiles comprise basic information on the vendor as well as a profile of the types of leads that they are willing to purchase. These profiles may specify a particular product or service category, a particular product or service, a defined geographic location of leads, a price maximum or range, a live transfer call window (9 am-5 pm EST, CT or PT), etc.

At the verification step 33, the consolidated/filtered leads are compiled into a list which is transmitted electronically to one or more outgoing call centers 50-1 . . . N (which may be in-house at the reseller or an independent contractor). Leads from the lead suppliers with the highest overall transfer ratio are sent to the call centers 50-1 . . . N first. This rewards the best-performing suppliers. The present method and network platform is capable of real time data communication between multiple call center operations, thus providing redundancy of the function and the ability to identify and optimize performance of multiple call center operations on a comparative side-by-side basis.

The leads are then double-confirmed by the call center which attempts to make contact with the lead prospects using power dialers. Each consolidated/filtered lead on a given list is loaded into power dialers and called for an optimized number of consecutive business days (currently three), until contact is made or not. Leads are called an average of 3 times per day and remain in the call center dial queue for a predetermined number of consecutive business days (currently 3). If no contact is made after the predetermined number of consecutive business days, the leads are removed from the list and the database. No payment is transacted with the lead supplier or from the matched vendors. If contact is made, then a live call center agent will pick up the call from the power dialer, “pre-qualify” the prospect orally, and confirm the prospect's interest in speaking directly to a vendor. Pre-qualification helps to ensure that the consumer is capable of making a purchase, qualifying for a loan, etc. The second or double-confirmation step is an essential feature of the present method because greatly increases the value of the lead and justifies the value-added proposition of the reseller.

During the verification step 33 the call center agent is provided with access to the reseller's web page which provides appropriate scripts, prospect information, vendor profile information, and appropriate questions for pre-qualification.

The conferencing feature with simultaneous web access to the database can be implemented by a conventional public switched telephone carrier with conferencing capability, assuming the call center agent and vendor both have concurrent computer access to the reseller's web page. Alternatively, more elaborate voice/data networks are available such as POTS/Packet Bridge architectures that let a call center agent with an ongoing Web connection call in to vendor agent, logging information to the reseller's database server, and transferring by a POTS call to the vendor agent and prospect. This latter form of network architecture also allows the Web page that the call center agent is looking to be passed to the vendor as well.

Given appropriate pre-qualification, the call center agent lastly confirms the prospects interest by asking them if they wish to speak directly to the vendor. Again, if the prospect is not qualified or not interested, the call is dropped and that lead is removed from the list and the database. No payment is transacted to the lead supplier or from the matched vendors. However, if the prospect is qualified and interested, the call center agent then places the prospect on hold. Next, at the vendor matching step 43, the call center agent initiates a matching process via the reseller website during which the consolidated/filtered/pre-qualified leads are automatically matched to the vendor profiles previously entered in the database 40. The lead data is compared to vendor profile product or service categories, particular products or services, the defined geographic location of leads versus vendors, price maximum or ranges, and current time versus vendor call windows (9 am-5 pm EST, CT or PT), etc. Vendor matching 43 is accomplished with a matching engine 60 that compares the collected lead data with vendor profiles. The matching engine 60 identifies the best suited vendor and presents the call center agent with that vendor profile. This in large part is accomplished with a software module that employs traditional heuristic matching (assigning values to both vendor profile parameters and lead data and performing a yes/no comparison, and in cases of more complex profiles may employ fuzzy logic to deal with uncertain information and variables that do not permit simple yes/no categorizations. Fuzzy logic is necessary only where matches are based on probability, not necessarily yes or no. The matching module presently employed utilizes qualitative yes/no matching in comparing the profiles to lead data, and identifies a subset of vendors seeking leads conforming to the discrete parameters of their profiles, such as those who sell a particular product or service category, a particular product or service, a defined geographic location of leads, a price maximum or range, etc. However, as the complexity of profiles increases the matching engine will necessarily increase and a variety of fuzzy logic approaches are envisioned.

Armed with the best-match vendor profiles, at step 53 the call center agent initiates a second call to a selected vendor, announcing a scripted “Hello, this is [call center agent's name] calling from the call center. I have John Doe on the line. His phone number is 949-555-1212”

The vendor agent likewise is provided with access to the reseller's web page during this stage which provides a telephone lookup function. The vendor agent enters the prospects phone number (given above) into a telephone lookup form on the reseller's website, and the phone number lookup brings up the lead sheet data associated with that prospect. Once the vendor agent confirms access to the lead sheet data associated with that prospect, the call center agent initiates the live transfer (shown at bottom). Specifically, the call center agent takes the prospect off of hold establishing a three-way conference call, and introduces the two parties by a scripted “Hello John, I have [loan officer's name]. He can help you with that product. Go ahead [loan officer's name]”. The call center agent drops off the teleconference and the vendor agent hopefully goes on to consummate a sale.

All conversations between prospects and the call center reps are recorded and are available for review within 24-hours of the transfer by logging into an administrative control section of the vendor or call center user account. This provides administrators with the ability for discreet management, processing, and reporting on the process.

Finally, payment is transacted at step 60. Immediately after live transfer, the vendor's account is debited for the price of the live transfer, and the lead supplier account is credited for the contingent purchase price of the successful lead. Actual payment is completed weekly for all live-transferred leads of the previous week. The payment price for each lead is derived from a sliding scale matrix based upon the supplier's overall transfer ratio.

Weekly Transfer Ratio Payout per Transfer

| | |
|---|---|
| 5% or Less | No Payment |
| 15% or Less | Base ($20, for example) |
| | A Sliding Scale Variable |
| 16%-74% | For example, Weekly Transfer |
| | Ratio (%) times 30 plus 12.5 |
| Greater than 75% | Max ($35, for example) |

Thus, for example, for 1000 leads that provide a 50% live transfer rate (resulting in 500 live hot transfers), the per-lead purchase price will be $33.40 resulting in a lead supplier payout of $16,700.00. For the same 1000 leads that provide a 15% live transfer rate (resulting in 150 live hot transfers), the per-lead purchase price will be $20 resulting in a lead supplier payout of $3000.00.

The lead suppliers may also login to the website 47 in order to view the status and dispositions of leads they provides to the reseller.

The above-described process ensures that the vendor is able to speak with a live interested and pre-qualified prospect 100% of the time. Moreover, the process provides the following advantages.

the capacity to receive leads from an unlimited number of supply channels, with discreet processing and reporting of each one.

comprehensive data scrubbing.

the capacity to manage a virtually unlimited number of vendors (along with their unique profiles and order parameters), with discreet management, processing, and reporting.

accommodates outsourcing to multiple call centers, thus providing redundancy of the function and the ability to identify and optimize performance of multiple call center operations on a comparative side-by-side basis.

The benefit to the vendor's sales agents is immediately apparent as they instantly become more productive thanks to a 100% contact rate of only interested and pre-qualified prospects.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

What is claimed is:

1. A method for value-added reselling of sales leads from multiple lead sources, comprising the steps of:
agreeing to purchase lead data from a plurality of lead suppliers at a price per lead that is contingent on the corresponding lead data conforming to predetermined parameters and ultimately maturing into a live telephone transfer of a consumer to a vendor;
inputting lead data from a plurality of lead suppliers;
consolidating said lead data;
storing said consolidated lead data in a central database;
filtering said consolidated lead data to eliminate duplicates and ensure that said lead data conforms to said predetermined parameters duplicates;
transmitting said filtered lead data to a call center for telephone contact of the corresponding consumer by a live call center agent;
contacting said consumer by telephone;
reconfirming that said consumer would like to speak to a vendor representative;
computer-matching said lead data to a suitable vendor profile;
joining a vendor representative from said vendor profile in a conference call with said consumer, and dropping off said conference call thereby completing a live transfer; and
collecting payment from said vendor for said live transfer, and paying said lead supplier for said lead data.

2. The method for value-added reselling of sales leads from multiple lead sources according to claim 1, wherein the price per lead paid is a sliding scale price dependent on a ratio of leads provided by the lead source that mature into a live transfer over total leads provided by a lead source.

3. The method for value-added reselling of sales leads from multiple lead sources according to claim 1, further comprising a step of subscribing a plurality of vendors and storing corresponding vendor profiles in said database.

4. The method for value-added reselling of sales leads from multiple lead sources according to claim 1, further comprising a step of providing said live call center agent with website access to said lead data and said vendor profiles while said call center agent contacts said consumer by telephone.

5. The method for value-added reselling of sales leads from multiple lead sources according to claim 4, further comprising a step of providing said live call center agent with a website script of pre-qualification questions to ask of said consumer by telephone.

6. The method for value-added reselling of sales leads from multiple lead sources according to claim 1, wherein said step of filtering said lead data comprises scrubbing said lead data against a federal Do-Not-Call list.

7. The method for value-added reselling of sales leads from multiple lead sources according to claim 2, wherein lead data from multiple lead suppliers is sent to said call center in an order that gives preference to the lead source with the highest live transfer ratio.

8. A method for value-added reselling of sales leads from multiple lead sources, comprising the steps of:
agreeing to purchase consumer lead data from said multiple lead sources contingent on the corresponding lead data maturing into a live telephone transfer of the associated consumer to a vendor;
contacting said consumer by telephone;
reconfirming that said consumer would like to speak to a vendor representative; and
joining a vendor representative in a three-way conference call with said consumer and dropping off said conference call to complete a live transfer; and
collecting payment from said vendor for said live transfer, and paying said lead supplier for the lead data.

9. The method for value-added reselling of sales leads from multiple lead sources according to claim 8, wherein said step of paying said lead supplier for the lead includes paying a sliding scale price only for lead data that matures into live transfers, the sliding scale price depending on a live transfer ratio of leads provided that mature into live transfers over total leads provided.

10. A method for value-added reselling of marketing leads of interested and pre-qualified prospects that are specifically matched to a vendor, comprising the steps of:
lead suppliers obtaining unqualified marketing leads by soliciting an expression of interest from prospects;
a lead reseller subscribing to a plurality of said lead suppliers to make contingent purchase of their leads, and subscribing various vendors who wish to purchase qualified leads, in each case opening an account that provides for merchant transactions, and for each subscribed vendor entering a vendor profile into a database specifying lead parameters sought by said vendors;
said lead reseller contracting with each subscribed lead supplier to purchase their leads on a contingent basis on the condition that said unqualified leads can be sold;
consolidating all marketing leads from the lead suppliers in an SQL database by data extraction and data migration;
scrubbing the lead data to ensure integrity by eliminating duplicate leads, eliminating leads containing phone numbers appearing on published do-not-call-lists, and filtering said lead data to eliminate bad or incomplete leads;
transmitting a queue of consolidated/filtered leads to one or more call centers who thereby initiate a first telephone call for double-confirmation of said leads, said double-confirmation comprising a verbal prequalification of the lead, and verbal confirmation of the lead prospect's interest in speaking to a vendor;
matching said consolidated/filtered leads to said vendor profiles to ensure that each selected lead for resale is targeted to one or more suitable vendors;
said call center initiating a second call to a selected vendor while concurrently providing said vendor access to the lead data, and initiating a live transfer of said first telephone call to said vendor;
debiting the vendor's account for payment upon a successful live transfer and crediting the lead supplier account for the contingent purchase price upon said successful live transfer.

11. The method for value-added reselling of sales leads from multiple lead sources according to claim 10, further comprising a step of recording all conversations between lead prospects and call center agents for review.

12. The method for value-added reselling of sales leads from multiple lead sources according to claim 10, wherein a price per lead paid is a sliding scale price dependent on a ratio of leads provided by a particular lead source that mature into a live transfer over total leads provided by a lead source.

13. The method for value-added reselling of sales leads from multiple lead sources according to claim 10, further comprising a step of subscribing a plurality of vendors and storing corresponding vendor profiles in said database.

14. The method for value-added reselling of sales leads from multiple lead sources according to claim 10, further comprising a step of providing said live call center agent with website access to said lead data and said vendor profiles while said call center agent contacts said consumer by telephone.

15. The method for value-added reselling of sales leads from multiple lead sources according to claim 14, further comprising a step of providing said live call center agent with a website script of pre-qualification questions to ask of said consumer by telephone.

16. The method for value-added reselling of sales leads from multiple lead sources according to claim 10, wherein said step of filtering said lead data comprises scrubbing said lead data against a federal Do-Not-Call list.

17. The method for value-added reselling of sales leads from multiple lead sources according to claim 11, wherein lead data from multiple lead suppliers is sent to said call center in an order that gives preference to the lead source with the highest live transfer ratio.

18. A method for value-added reselling of sales leads from multiple lead sources, comprising paying each lead source a sliding scale price per lead that corresponds to a ratio comprising a number of leads provided from said lead source that mature into a live telephone transfer of consumer to vendor over a total number of leads provided from said lead source.

19. A method for value-added reselling of sales leads from multiple lead sources, comprising paying each lead source a price per lead contingent on each said lead maturing into a live telephone transfer of consumer to vendor.

20. The method for value-added reselling of sales leads according to claim 19, further comprising a step of paying each lead source a sliding scale price per lead that corresponds to a ratio comprising a number of leads provided from said lead source that mature into a live telephone transfer of consumer to vendor over a total number of leads provided from said lead source.
